(19) United States
(12) Patent Application Publication
(10) Pub. No.: US 2005/0155229 A1
(43) Pub. Date: Jul. 21, 2005

(54) Tableware

(76) Inventor: Ching Mou Lee, Guangdong (CN)

Correspondence Address: MICHAEL L. DIAZ, P.C., 555 REPUBLIC DRIVE, SUITE 200, PIANO, TX, 75074, US

(21) Appl. No.: 10/902,649

(22) Filed: Jul. 28, 2004

(30) Foreign Application Priority Data
Jan. 16, 2004 (CN) 2004200150941

(51) Int. Cl. A47J 43/28

(52) U.S. Cl. 30/322; 30/324

(57) ABSTRACT

The present invention relates to tableware. The tableware includes a handle and a holding section connected with the handle. The cross-section of the handle is “M”-shaped, with a “V”-shaped groove extending from the middle of the handle to the holding section, and at least one V-shaped groove being positioned in the middle of the holding section. The above-mentioned parts make up the strengthened tableware. The “M”-shaped and “W”-shaped grooves strengthen the handle, the palm and the finger of the tableware. On the other hand, the manufacturing and concave points located at the “M”-shaped groove of the front surface and the “W”-shaped groove of the back surface of the tableware enable the tableware to overlap closely and steadily because of a parallel-wave structure principle. Different types or the same type of tableware can overlap closely.

### BACKGROUND OF THE INVENTION

1. Field of the Invention

The present invention relates generally to tableware, and in particularly to tableware that has the functions of a knife, a fork and a spoon, and more particularly, to a one piece plastic tableware.

2. Description of the Related Art

Many traditional tableware pieces are designed to have flat handles and thickened borders. Furthermore, to enhance the integrity of the tableware, the size of the parts of the tableware must be enlarged or strengthening ribs must be affixed to the tableware. Therefore, it would use more material to produce the above strengthened tableware and very wasteful. Meanwhile, packages for the strengthened tableware also occupy more space, which also require more room for stocking, and increases space during transportation. So it is more expensive to manufacture, pack, transport, and store, as well as being inconvenient to keep at home or to take outside.

A bound set of disposable cutlery is disclosed in U.S. Pat. No. 5,904,250. The bound set comprises a tablespoon, a table fork and a table knife which are overlapped together. Alternately, the same tableware, such as table forks are overlapped. The table ware is designed to overlap firmly from the back to the front one by one, and thus, saves space for packing. But the tableware is designed to be a U-shaped structure, that is, the D-value between the thickness of the edges cannot match the two plastic bevel edges well. Therefore, the tableware leaves some space in the package. Meanwhile, in order to strengthen the cutlery, the cutlery must be thickened about the borders of the tableware, thereby enlarging the volume and the weight of each piece of tableware. However, this is very costly. Moreover, the packaging requires more space because of the thickened borders of each tableware piece. Another disadvantage is that the borders of the tableware must be heightened and widened so as to strengthen the part extending from the fork handle to the fork palm and from the fork palm to the fork finger because of the U-shaped structure. This configuration leads to mismatched overlap. In addition, the package occupies more space.

For another example, U.K. Pat. No. 2177894A discloses a branch of three kinds of tableware (a table knife, a table fork, and a tablespoon). There is a projecting point on the front and the back of the handle of the table knife. The point on the table knife can buckle to a corresponding concave point of the table fork or the tablespoon. The table knife, the table fork and the tablespoon can overlap together to be a nest. However, the same kind of tableware cannot be overlapped together and each nest must be separated. Furthermore, the tableware wastes a considerable amount of material for packing. In addition, the tableware is not strong enough to use.

### SUMMARY OF THE INVENTION

The object of the present invention is to provide tableware, such as a table knife, a table fork and a table spoon. The same category of the tableware can overlap together, and a plurality of the same tableware or different tableware can also be packed together firmly and closely. Thus it saves space in packing, transporting and storing. The present invention is economical and portable for using, and benefits the environment and economy.

In order to achieve the above object, the present invention provides a tableware comprising a handle, a holding section integrated with the handle. The cross-section of the handle is “M”-shaped and includes a “V”-shaped groove in the middle of the handle which extends to a holding section. At least one V-shaped groove is set in the middle of the holding section.

There are several advantages of the present invention. The handle and holding section of the tableware have the “M”-shaped (“W”-shaped in the back part) and the “V”-shaped grooves. Because of the “M”-shaped and the “W”-shaped grooves, the strength of the handle, neck portion and fork fingers are enhanced. On the other hand, the tableware can overlap together firmly and match each other well because of the “M”-shaped grooves on the tableware's front surface and the “W”-shaped grooves on the tableware's back surface have projecting and concave points which are all parallel in a waved shape. A plurality of the tableware can overlap with each other firmly, and the same tableware can overlap together entirely. Thus the packaging of the tableware is more compact. In addition one piece of tableware is strong enough to use even if it is manufactured by a minimal amount of materials. Therefore, it is economical for manufacturing, transporting and storing and is portable.

The same tableware of the present invention can overlap together and are packed in one package. The configuration of the package for the tableware is much stronger. In addition, the packaging is sized to fit approximately the same size as each piece of tableware. The tableware saves space for packing, transportation and storing. The package prevents the tableware from rubbing against the surface and damaging the body through impact during transporting and storing of the tableware. Similarly, each wave crest and trough of the M-shaped, W-shaped, V-shaped waved board structure acts as a strengthen grid. The more wave crests and troughs, the greater the strength of the tableware. The tableware is manufactured by a thin board that does not need a strengthening grid because of the “M”-shaped, “W”-shaped, “V”-shaped waved configurations for the handles and the holding section, which, strengthen the tableware. It solves the problem that one tableware should be sufficiently strong, while at the same time should save the material.

The size of the pack is almost equal to the summation of the size of each tableware. The tableware may be counted by machine automatically and is applicable for use with sales-machines automatically. Thus, tableware do not need to be counted manually. In addition, the tableware may be more easily packaged by machine.

Because of the V-shaped fork-finger and fork-neck, the surface of the fork-finger and the fork-neck meet the food directly. The tableware is also more portable. Moreover, the tableware has great strength, is unbreakable, and is safe to use.

In addition, because of the V-shaped and W-shaped groove structure, the fork-handle and fork-neck, fork-finger are stronger than the tableware that is thickened upon its borders or that has a U-shaped structure handle. Regarding the condition of the same weight and same size, the strength of the tableware is enhanced. The table fork, knife and spoon are manufactured in the same configuration, thereby allowing different types of tableware to overlap together. Additionally, because the present invention may be manufactured by integrated injection molding from plastic or metal, material is saved while still strengthening the tableware.

### BRIEF DESCRIPTION OF THE DRAWINGS

FIG. 1 is a perspective view showing tableware in accordance with a first embodiment of the present invention;

FIG. 2 is a front view of the tableware shown in FIG. 1;

FIG. 3 is a cross-section view of the handle of the table fork shown in FIG. 1 in the direction of A-A;

FIG. 4 is a cross-section view of the neck of the table fork shown in FIG. 1 in the direction of B-B;

FIG. 5 is a cross-section view of the finger of the table fork shown in FIG. 1 in the direction of C-C;

FIG. 6 is a perspective view of a package for many table fork shown in FIG. 1 to overlap and match each other;

FIG. 7 is a magnified view of the package of the fork handles shown in FIG. 3 to overlap and match each other in the direction of A-A;

FIG. 8 is a magnified view of the package of the fork neck shown in FIG. 4 to overlap and match each other in the direction of B-B;

FIG. 9 is a magnified view of the package of the fork finger (as in FIG. 5) to overlap and match each other in the direction of B-B;

FIG. 10 is a perspective view of the structure of a table spoon in accordance with a second embodiment of the present invention;

FIG. 11 is a cross-section view of the handle of the table spoon shown in FIG. 10 in the direction of A-A;

FIG. 12 is a cross-section view of the bottom of the table spoon shown in FIG. 11 in the direction of A-A;

FIG. 13 is a perspective view of the structure of a table knife in accordance with a third embodiment of the present invention;

FIG. 14 is a cross-section view of the handle of the table knife shown in FIG. 13 in the direction of A-A;

FIG. 15 is a cross-section view of the bottom of the table knife shown in FIG. 13 in the direction of A-A;

FIG. 16 is a perspective view of the structure of a table fork in accordance with a fourth embodiment of the present invention;

FIG. 17 is a diagrammatic view showing a plurality of table forks shown in FIG. 16 overlapping together;

FIG. 18 is a perspective view of the structure of a table knife in accordance with a fifth embodiment of the present invention; and

FIG. 19 is a diagrammatic view showing a plurality of table knifes shown in FIG. 18 overlapping together.

### DESCRIPTION OF THE INVENTION

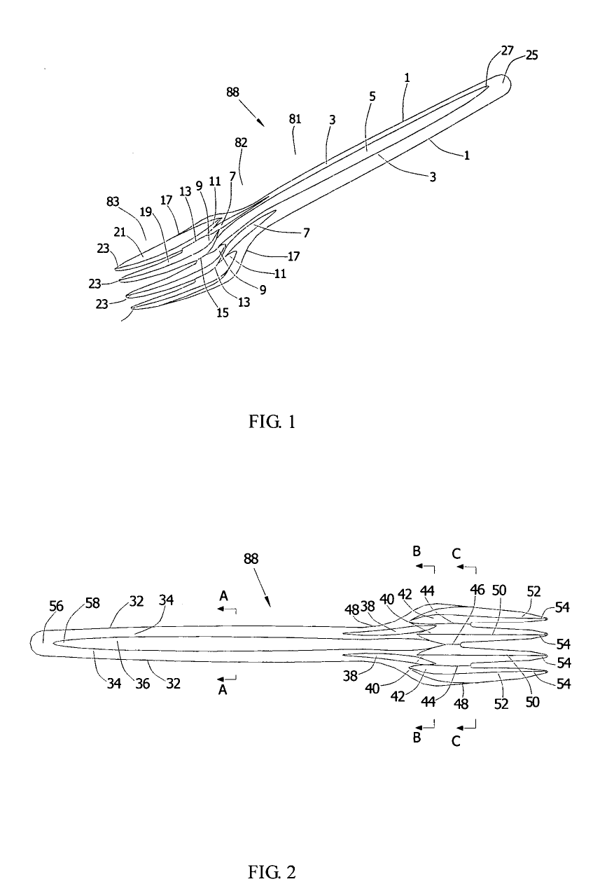

The present invention provides tableware having the functions of a table fork, a tablespoon and a table knife. As shown in FIGS. 1, 10 and 13, the same portion is labeled with the same number, such as a tablespoon is labeled 84, a table knife is labeled as 86 and a table fork is labeled as 88.

The tableware comprises a handle 81 and a corresponding holding section 82 (also 83) that connects with the handle 81, to make up the strengthened tableware. The cross-section of the handle 81 is “M”-shaped. There is a “V”-shaped groove 5 in the front surface of the handle 81. The groove 5 separately extends from the bottom to the surface of the handle 81 along two ends of a “V”-shaped arc, and intersects with the both sides of brachial portions 1 of the handle 81 to form two arrow-cone-tips 3. The two arrow-cone-tips 3 are coplanar and in an equal height, and connect with the bottom of the brachial portions 1, and form the M-shaped-waved configuration and strengthened handle 81.

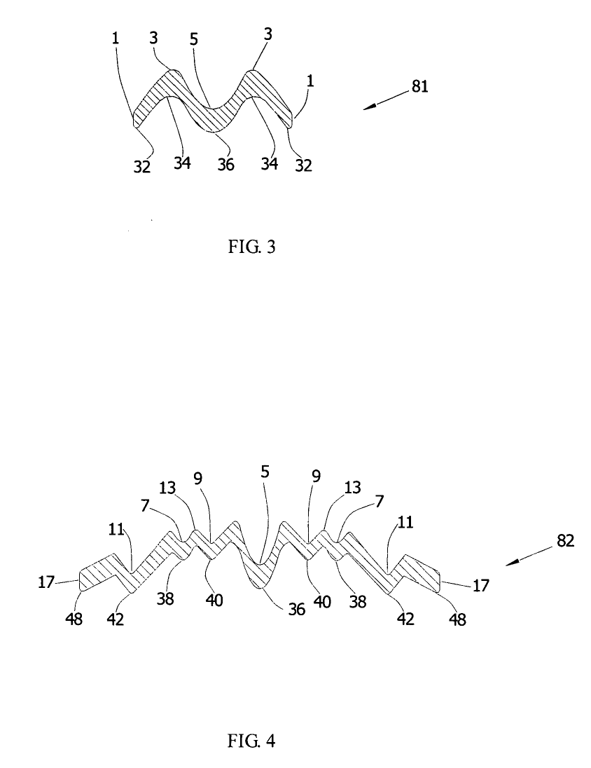

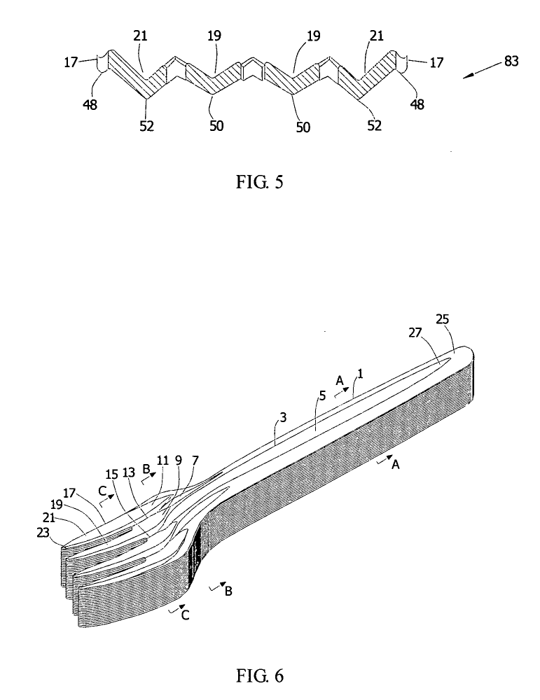

FIGS. 1, 2 and 3 illustrate a table fork. The two arrow-cone-tips 3 on the handle 81 of the table fork, the two brachial portions 1 and the V-shaped groove 5 extend forward through the transitional “V”-shaped groove 7, to form the functional parts 9, 11, 13 which extend to both sides. Additionally, the grooves are waved-shape. The groove 5 tapers off and combines with the neck of the handle to form the M-shaped-waved strengthened neck portion.

As show in FIG. 1, the transitional “V”-shaped grooves 7 of the neck portions 82 extend down the two outer sides of the arrow-cone-tips 3 of the head of the handle 81 in the shape of an arc and intersect with the waved-shaped top face 13, 17 of the neck portions 82.

As shown in FIGS. 1, 2, 3, an arrow-cone-tip 15 is composed of coplanar points connected with a “V”-shaped curve groove 9 of the neck portion 82. The arrow-cone-surface tip 15 connects with an angular line of the “V”-shaped groove 5 of the handle 81, extends to the end of the handle 81, and tapers off gradually and terminates at the trail of the handle 81 to form the strip of strengthened “M”-shaped handle. The trail of the handle 81 is in a shape of a hemisphere.

As show in FIG. 4, the coplanar and connected points of the two pairs of “V”-shaped curve grooves 9 and 11 of the neck portion 82 compose the “W”-shaped arrow-cone-surface tip 13. The point of the “W”-shaped arrow-cone-surface tip 13 connects and is separately coplanar with a base angle line of a part of curve “V”-shaped groove 7.

The “V”-shaped curve grooves 9, 11 of the palm-core split and extend forward to the fork-fingers through the integration parts 19, 21, then get thinner, and bond with the fork-finger 23 to form the strengthened and micro-arc “V”-shaped fingers 83 of the table fork.

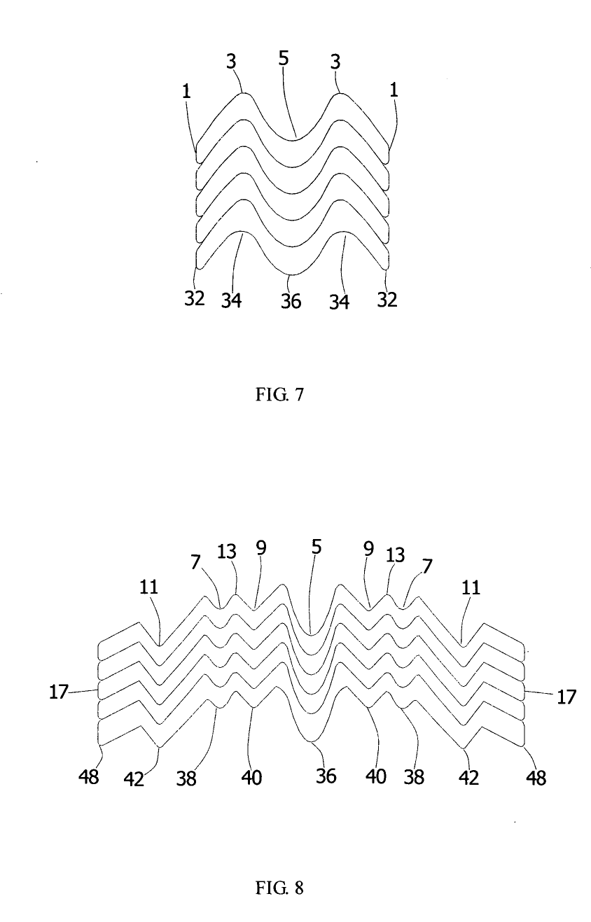

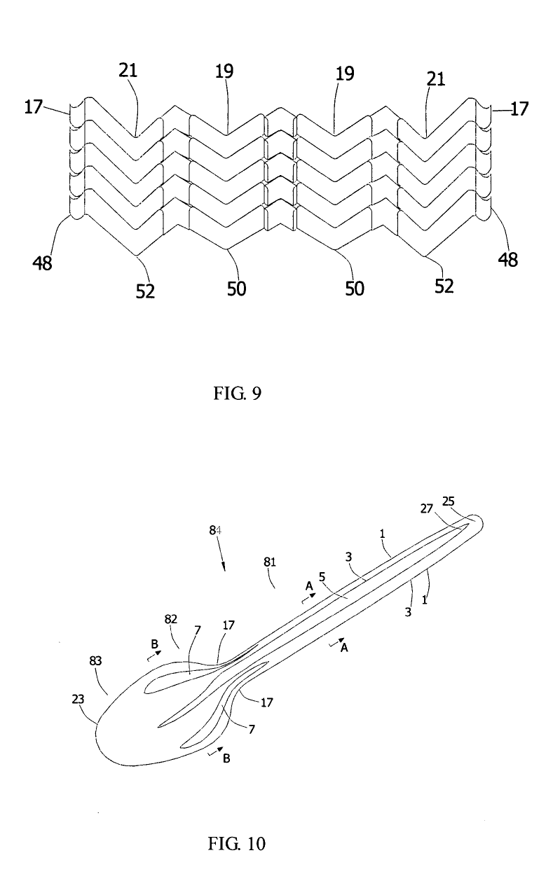

As shown in FIGS. 6, 7, 8 and 9, not only does the handle of each tableware overlap with each other well, but also the extending and operating parts 82, 83 similarly overlap well. The tableware can be tightly and steadily packed. The package of the tableware holds the maximum amount of the tableware, has the minimum volume, and has superior strength.

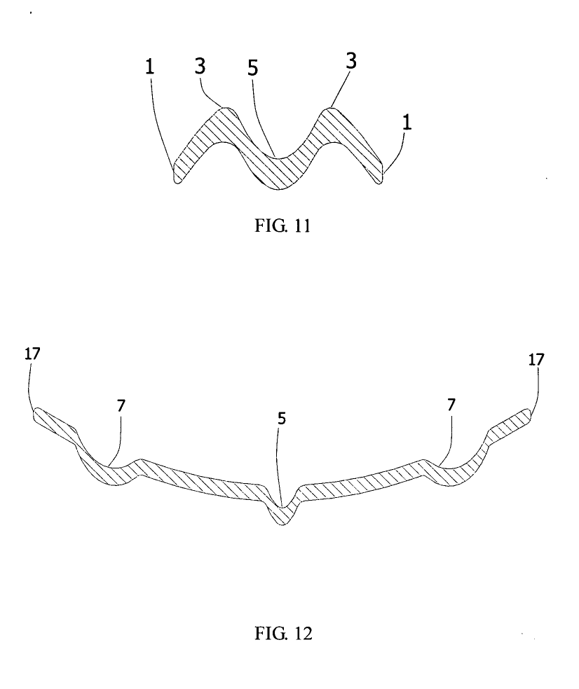

As shown in FIGS. 10, 11 and 12, a tablespoon is disclosed. A handle of the spoon is similar to the table fork as described above. M-shaped handles 1, 3, 5 extend forward to the operating parts 7, 17 and strengthen the whole body of the tableware. V-shaped strengthened grooves 5, 7 taper gradually and terminate at the middle of the tablespoon, then join to a part 23 to form the strengthened tablespoon.

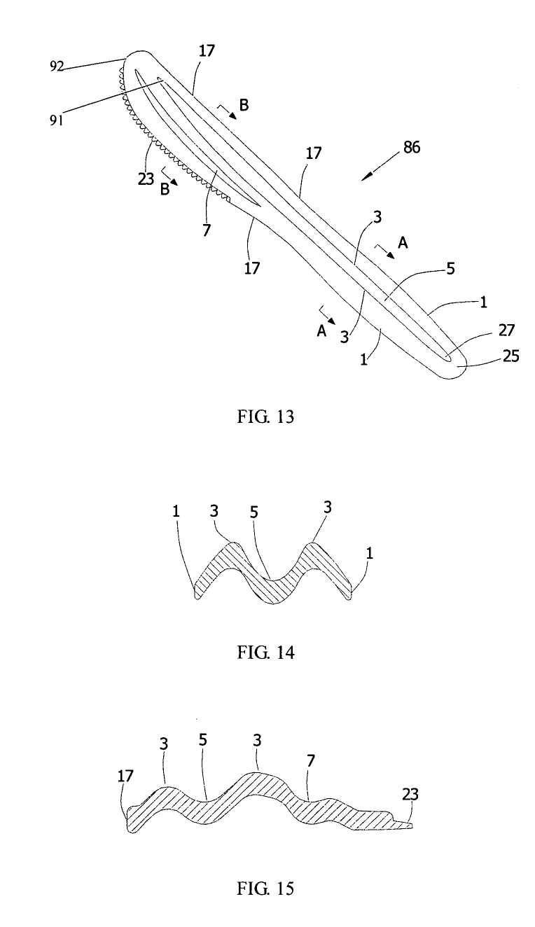

As shown in FIGS. 13, 14 and 15, a table knife is disclosed. A handle of the table knife is similar to the table fork as described above. M-shaped handles 1, 3, 5 extend forward to the operating part 17 and strengthen the part 23 of the table knife. The V-shaped strengthened grooves 5, 7 taper gradually at the integration part 91 and terminate at the front end 92 of the knife and form the strengthened tablespoon.

As the above-mentioned tableware of the present invention, the front of the handle has an M-shaped configuration, and the back has a W-shaped configuration. The V-shaped strengthened groove 5 extends and tapers gradually from the middle of handle 81 to the trail of the handle 81, and joins with the trail part 25 to be hemisphere-shaped, to form the strengthened handle. Thus the handle is strong enough to operate and overlap with other tableware.

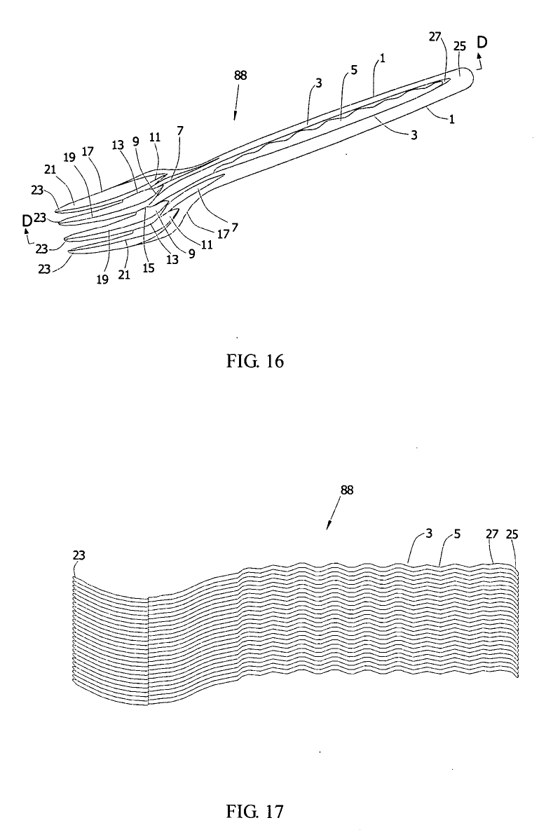

As shown in FIGS. 16 and 17, the handle of the table fork of the present invention can be further improved. The longitudinal direction of the middle of the fork handle may set many V-shaped structures which connect with each other along the M-shaped structure to form a horizontal waved-type table fork 88. As show in FIG. 17, this kind of table fork is much more rigid and much steadier when several pieces of tableware are overlapped together.

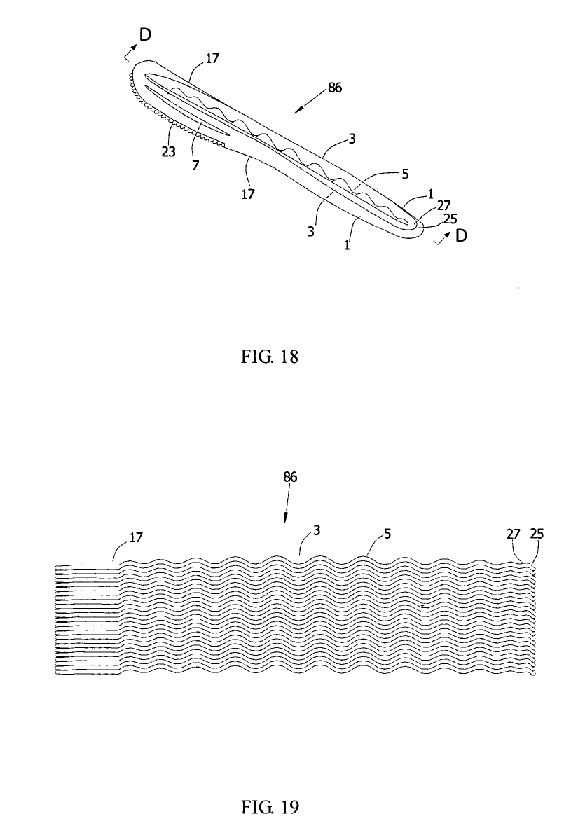

As shown in FIGS. 18 and 19, the table knife of the present invention can be further improved. The longitudinal direction of the middle of the fork handle may set many V-shaped structures which connect with each other along the M-shaped structure to form a horizontal waved-type table knife 86. As show in FIG. 19, this kind of table knife is much more rigid and much steadier when several pieces of tableware are overlapped together.

The other structure of handle of the tablespoon is similar to the other two kinds of tableware as the above-mentioned table knife and table fork.

While the tableware of the present invention are packed, as shown in FIGS. 6, 7, 8 and 9, the protruding surface of the W-shaped cone-shaped surfaces 36, 50, 52, 38, 40, 42, 44 and 46 of the back of one tableware direct to the front concave surface of the W-shaped cone-shaped surfaces 5, 7, 9, 11, 13, 19 and 21. Guided by V-shaped grooves on the front of each piece of tableware, every point in the corresponding site approaches to and contacts with a corresponding point on the other tableware. The same tableware types overlap to form one body. In addition, different types of tableware can also overlap closely and firmly. Thus, it will save materials for packing.

V-shaped, M-shaped and W-shaped strengthened structure lead points and surfaces of the tableware of the present invention all have the same thickness. Therefore, the tableware can be manufactured by injection molding. The tableware of the present invention is twice as rigid as that of the other tableware when they are at the same weight. The tableware of the present invention may be manufactured by molding with plastic or metal integrally constructed within the tableware, thereby saving material and strengthening the tableware.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A tableware, the tableware comprising:
a handle having a holding section integral with the handle;
the cross-section of the handle is “M”-shaped;
a “V”-shaped groove in the middle of the handle extends to the holding section; and
at least one V-shaped groove is positioned in the middle of the holding section.

2. The tableware of claim 1 wherein:
the tableware is a table fork;
a strip of “V”-shaped groove is positioned in the front surface of the handle;
the “V”-shaped groove separately extends from the bottom surface of the handle along two ends of a “V”-shaped arc, and intersects with both sides of brachial portions of the handle to form two arrow-cone-tips, the two arrow-cone-tips being coplanar and in an equal height with each other and connecting with the bottom of the brachial portions;
the holding section includes a plurality of fork-fingers and a neck portion which integrate with the handle;
the two arrow-cone-tips, the two brachial portions and the “V”-shaped groove extend forward through the transitional “V”-shaped groove of the neck portion and form a plurality of functional parts which extend to both sides of the handle in a waved-shape;
the “V”-shaped groove is tapered and combined with the neck portion; and
each of the fork-fingers in “V”-shaped groove tapers off to the core of the neck portion along the head of the fork-finger, extends, integrates, and intersects with the waved-shaped surface of the neck portion.

3. The tableware of claim 1 wherein:
the tableware is a tablespoon;
a strip of “V”-shaped groove is positioned in the front of the handle;
the “V”-shaped groove separately extends from the bottom surface of the handle along two ends of a “V”-shaped arc, intersects with the both sides of brachial portions of the handle, and form two arrow-cone-tips, the two arrow-cone-tips being coplanar and in an equal height with each other and connect with the bottom of the brachial portions;
the holding section includes a spoon and a neck portion which integrates with the handle;
the “V”-shaped groove extends to the middle of the spoon, and two transitional “V”-shaped grooves are positioned in the neck portion and extends to the middle of the spoon; and
the front ends of the transitional “V”-shaped groove and the “V”-shaped groove taper off and terminate at the middle of the spoon.

4. The tableware of claim 1 wherein:
the tableware is a table knife;
a strip of “V”-shaped groove is positioned in the front surface of the handle;
the “V”-shaped groove separately extends from the bottom surface of the handle along two ends of a “V”-shaped arc, and intersects with the both sides of brachial portions, and forms two arrow-cone-tips, the two arrow-cone-tips being coplanar and in an equal height with each other, and connecting with the bottom of the brachial portions;
the holding section including a knife and a neck portion which integrate with the handle;
the “V”-shaped groove extends to the front end of the knife, and the knife has a V-shaped groove;
the brachial portions, the arrow-cone-tips, and the “V”-shaped groove of the handle extend forward and connect with a transitional “V”-shaped groove to strengthen the knife, and the arrow-cone-tips and the “V”-shaped groove extending forward and terminating at the front end of the knife.

5. The tableware of claim 2 wherein:
the front surface of the handle is “M”-shaped and the back surface is “W”-shaped;
the “V”-shaped groove tapers off from the middle of the handle to the trail of the handle, ending at the trail, and combining with the trail part in a hemisphere.

6. The tableware of claim 3 wherein:
the front surface of the handle is “M”-shaped and the back surface is “W”-shaped;
the “V”-shaped groove tapers off from the middle of the handle to the trail of the handle, ending at the trail, and combining with the trail part to in a hemisphere.

7. The tableware of claim 4 wherein:
the front surface of the handle is “M”-shaped and the back surface is “W”-shaped;
the “V”-shaped groove tapers off from the middle of the handle to the trail of the handle, ending at the trail, and combining with the trail part in a hemisphere.

8. The tableware of claim 2 wherein the table fork has four fork-fingers and the cross-section of the each finger is “V”-shaped.

9. The tableware of claim 2 wherein the holding section has two strips of transitional “V”-shaped grooves which are symmetrically set.

10. The tableware of claim 3 wherein the holding section has two strips of transitional “V”-shaped grooves which are symmetrically set.

11. The tableware of claim 4 wherein the holding section has a strip with a transitional “V”-shaped groove.

12. The tableware of claim 2 wherein a plurality of “W”-shaped portions are positioned in the middle of the handle at the longitudinal direction.

13. The tableware of claim 3 wherein a plurality of “W”-shaped portions are positioned in the middle of the handle at the longitudinal direction.

14. The tableware of claim 4 wherein a plurality of “W”-shaped portions are positioned in the middle of the handle at the longitudinal direction.
